(19) United States
(12) Patent Application Publication
(10) Pub. No.: US 2019/0381702 A1
(43) Pub. Date: Dec. 19, 2019

(54) FORMABLE RESIN SHEET, PRODUCTION METHOD FOR FORMABLE RESIN SHEET, AND PRODUCTION METHOD FOR SHAPED OBJECT

(71) Applicant: Casio Computer Co., Ltd., Tokyo (JP)

(72) Inventor: Hideki TAKAHASHI, Ome-shi (JP)

(21) Appl. No.: 16/437,987

(22) Filed: Jun. 11, 2019

(30) Foreign Application Priority Data
Jun. 19, 2018 (JP) 2018-116535

(51) Int. Cl. B29C 35/08

(52) U.S. Cl. CPC B29C 35/0805; B29K 2101/12; B29C 2035/0822

(57) ABSTRACT

A formable resin sheet includes a thermally expansive layer formed on a first side of a base and including a thermally expandable material. A breaking strength of the thermally expansive layer is greater than a peeling strength of the thermally expansive layer from the base, and the thermally expansive layer is peelable from the base. The formable resin sheet can easily be shaped by using a thermal conversion layer to cause the thermally expansive layer to distend and cause the base to deform as the thermally expansive layer distends. The thermally expansive layer can be removed after the shaping of the base.

### CROSS-REFERENCE TO RELATED APPLICATION

This application claims the benefit of Japanese Patent Application No. 2018-116535, filed on Jun. 19, 2018, the entire disclosure of which is incorporated by reference herein.

### FIELD

The present disclosure relates generally to a formable resin sheet that uses a thermally expansive layer including a thermally expandable material that foams and expands according to the amount of heat absorbed, a production method for the formable resin sheet, and a production method for a shaped object using the formable resin sheet.

### BACKGROUND

Switches such as membrane switches are used in the related art as inputter. Examples of such inputters include numbers on electronic devices. Resin sheets that have been subjected to embossing, for example, are used for the membrane switches. Additionally, in the embossing, the sheet is molded into a desired shape using a concave mold and a convex mold (see, for example, Unexamined Japanese Patent Application Kokai Publication No. H06-8254).

In such a method, molds that correspond to the desired shape must be prepared before molding the resin sheet. As such, time and cost are required to manufacture the molds, which is a problem.

Manufacturing molds can increase the time required for development, particularly at the prototype fabrication stage. As such, there is a demand for easily shaping resin sheets without the need for molds.

The present disclosure is made with the view of the above situation, and an objective of the present disclosure is to provide a formable resin sheet that can be easily shaped, a production method of the formable resin sheet, and a production method of a shaped object.

### SUMMARY

According to an aspect of the present disclosure, a formable resin sheet includes a base made from a resin, and a thermally expansive layer provided on a first side of the base and including a thermally expandable material. A breaking strength of the thermally expansive layer is greater than a peeling strength of the thermally expansive layer from the base, and the thermally expansive layer is peelable from the base.

According to a further aspect of the present disclosure, a formable resin sheet includes a base made from a resin, a thermally expansive layer provided on a first side of the base and including a thermally expandable material, and an intermediate layer provided between the base and the thermally expansive layer. A peeling strength between the intermediate layer and the base is less than a peeling strength between the thermally expansive layer and the intermediate layer, and the intermediate layer is peelable from the base together with the thermally expansive layer.

According to another aspect of the present disclosure, a method for producing a formable resin sheet includes forming a thermally expansive layer on a first side of a base made from a resin. The thermally expansive layer includes a thermally expandable material. A breaking strength of the thermally expansive layer is greater than a peeling strength of the thermally expansive layer from the base, thereby making the thermally expansive layer peelable from the base.

According to still further aspect of the present disclosure, a method for producing a formable resin sheet includes forming an intermediate layer on a first side of a base made from a resin, and forming a thermally expansive layer on the intermediate layer. The thermally expansive layer includes a thermally expandable material. A peeling strength between the intermediate layer and the base is less than a peeling strength between the thermally expansive layer and the intermediate layer, thereby making the intermediate layer peelable from the base together with the thermally expansive layer.

According to still another aspect of the present disclosure, a method for producing a shaped object using a formable resin sheet that includes a base and a thermally expansive layer formed on a first side of the base and including a thermally expandable material, wherein a breaking strength of the thermally expansive layer is greater than a peeling strength of the thermally expansive layer from the base, and the thermally expansive layer is peelable from the base, includes forming, on at least one of the thermally expansive layer or the base, a thermal conversion layer that converts electromagnetic waves to heat, irradiating the thermal conversion layer with the electromagnetic waves to cause the thermally expansive layer to distend and cause the base to deform as the thermally expansive layer distends, and peeling the thermally expansive layer from the base.

According to yet still another aspect of the present disclosure, a method for producing a shaped object using a formable resin sheet that includes a base and a thermally expansive layer formed on a first side of the base and including a thermally expandable material, wherein an intermediate layer is provided between the thermally expansive layer and the base, and a peeling strength between the intermediate layer and the base is less than a peeling strength between the thermally expansive layer and the intermediate layer, thereby making the intermediate layer peelable from the base together with the thermally expansive layer, includes forming, on at least one of the thermally expansive layer or the base, a thermal conversion layer that converts electromagnetic waves to heat, irradiating the thermal conversion layer with the electromagnetic waves to cause the thermally expansive layer to distend and cause the base to deform as the thermally expansive layer distends, and peeling the thermally expansive layer from the base.

### BRIEF DESCRIPTION OF THE DRAWINGS

A more complete understanding of this application can be obtained when the following detailed description is considered in conjunction with the following drawings, in which:

FIG. 1 is a cross-sectional view illustrating an overview of a formable resin sheet according to Embodiment 1;

FIGS. 2A and 2B are cross-sectional views illustrating a production method for the formable resin sheet according to Embodiment 1;

FIG. 3A is a drawing illustrating a state in which a thermally expansive layer of the formable resin sheet according to Embodiment 1 is distended;

FIG. 3B is a drawing illustrating an overview of a shaped object according to Embodiment 1;

FIG. 4 is a plan view illustrating an example of the shaped object;

FIG. 5A to 5C are drawings illustrating the configuration of a shaping system used in a production method for the shaped object according to Embodiment 1;

FIG. 6 is a flowchart illustrating the production method for the shaped object according to Embodiment 1;

FIGS. 7A to 7C are cross-sectional views schematically illustrating the production method for the shaped object according to Embodiment 1;

FIG. 8 is a cross-sectional view illustrating an overview of a formable resin sheet according to Embodiment 2;

FIGS. 9A to 9C are cross-sectional views illustrating a production method for the formable resin sheet according to Embodiment 2;

FIG. 10A is a drawing illustrating a state in which a thermally expansive layer of the formable resin sheet according to Embodiment 2 is distended;

FIG. 10B is a drawing illustrating an overview of a shaped object according to Embodiment 2;

FIGS. 11A to 11C are cross-sectional views schematically illustrating the production method for the shaped object according to Embodiment 2;

FIG. 12 is a flowchart illustrating a production method for a shaped object according to Embodiment 3; and

FIGS. 13A to 13D are cross-sectional views schematically illustrating the production method for the shaped object according to Embodiment 3.

### DETAILED DESCRIPTION

Hereinafter, the drawings are used to describe, in detail, a formable resin sheet, a production method for the formable resin sheet, and a production method for a shaped object according to embodiments of the present disclosure.

In this application, the term “shaped object” refers to a formable resin sheet in which shapes such as simple shapes such as convexities (protrusions) and concavities (recesses), geometrical shapes, characters, patterns, and decorations are shaped (formed) on a predetermined side of the formable resin sheet. The term “decorations” refers to objects that appeal to the aesthetic sense through visual and/or tactile sensation. The term “shaping (or molding)” refers to the forming of a shaped object, and should be construed to also include concepts such as decorating and ornamenting. The shaped object of the present embodiment is a three-dimensional object that includes unevennesses, geometrical shapes, decorations, or the like on a predetermined side. However, to distinguish this three-dimensional object from three-dimensional objects formed using a so-called 3D printer, the shaped object of the present embodiment is called a 2.5-dimensional (2.5D) object or a pseudo-three-dimensional (pseudo-3D) object. Moreover, the technique used to produce the shaped object of the present embodiment is called 2.5D printing or pseudo-3D printing.

In the present description, for ease of description, the side of the formable resin sheet where the thermally expansive layer is provided is referred to as the front side (front surface) or the top surface, and the side of the formable resin sheet where the base is provided is referred to as the back side (back surface) or the bottom side. The terms “front”, “back”, “top”, and “bottom” should not be construed to limit the method of use of the formable resin sheet. That is, depending on the method of use of the shaped resin sheet, the back side of the formable resin sheet can be used as the front side. The same is applicable to the shaped object as well.

### Embodiment 1

### Formable Resin Sheet 10

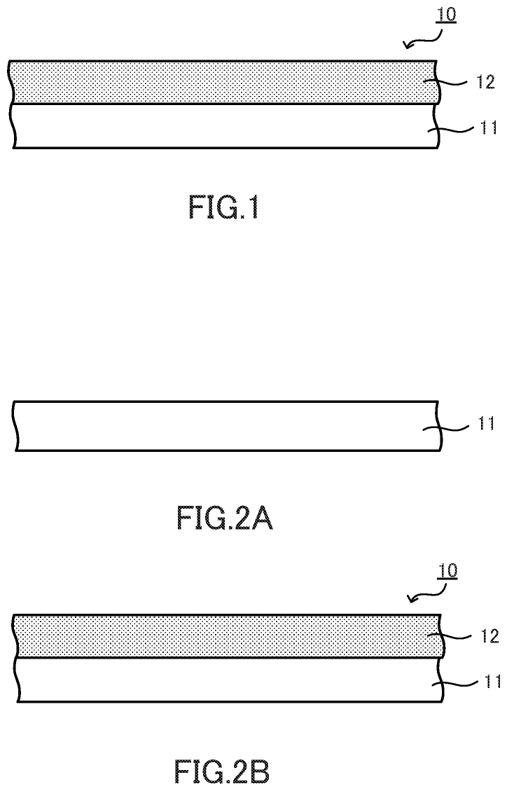

As illustrated in FIG. 1, the formable resin sheet 10 includes a base 11 and a thermally expansive layer 12 provided on a first side (the top surface illustrated in FIG. 1) of the base 11. While described in detail later, in the formable resin sheet 10, the distending force of the thermally expansive layer 12 is used to deform the base 11 such that the base 11 conforms to the direction in which the thermally expansive layer 12 distends. The base 11 retains the shape that result from the deformation. As a result, the base 11 of the formable resin sheet 10 is deformed and shaped.

The base 11 is implemented as a sheet-like member that supports the thermally expansive layer 12. The thermally expansive layer 12 is provided on a first side (the top surface illustrated in FIG. 1) of the base 11. The base 11 is a sheet that is formed from a thermoplastic resin. While not limited hereto, examples of the thermoplastic resin include polyolefin resins such as polyethylene (PE) and polypropylene (PP), polyethylene terephthalate (PET), polyethylene naphthalate (PEN), polybutylene terephthalate (PBT), polyester resins, polyamide resins such as nylon, polyvinyl chloride (PVC) resins, polystyrene (PS), polyimide resins, and the like. In order to facilitate the deformation, it is preferable that a non-oriented film, such as a non-oriented PET film, is used as the base 11.

The thermally expansive layer 12 has lower visible light transmittance than the transparent or semi-transparent base 11, and the visible light transmittance of the thermally expansive layer 12 is particularly low at the distended portion. As such, when the thermally expansive layer 12 is disposed on the transparent or semi-transparent base 11, the thermally expansive layer 12 causes a decrease in the visible light transmittance. However, in the present embodiment, as described later, the thermally expansive layer 12 can be peeled. Therefore, the thermally expansive layer 12 is particularly advantageous in the shaping of transparent or semi-transparent bases.

The base 11 is preferably easily deformable by heat. As such, the material used as the base 11, the thickness of the base 11, and the like may be determined such that the base 11 is easily deformed by heat. In addition, the shape of the base 11 after deformation must be maintained. As such, the material used as the base 11, the thickness of the base 11, and the like are determined such that the shape of the base 11 after deformation can be maintained. The material, the thickness, and the like of the base 11 are designed so as to be suited to the application of the produced shaped object 20. For example, depending on the application of the shaped object 20, there are cases in which, instead of simply maintaining the deformed shape, the shaped object 20 must have elastic force that allows the shaped object 20 to return to the original shape after having been pressed and deformed. In such a case, the material of the base 11 is determined so as to provide the deformed base 11 with the required elastic force.

The thermally expansive layer 12 is provided on a first side (the top surface in FIG. 1) of the base 11. The thermally expansive layer 12 is a layer that distends to a size that corresponds to the heating process (for example, the heating temperature and heating time), and includes a thermally expandable material (thermally expandable microcapsules, micropowder) dispersed/disposed in a binder.

The thermally expansive layer 12 is not limited to including one layer and may include a plurality of layers. Any thermoplastic resin, such as an ethylene-vinyl-acetate polymer or an acrylic polymer, may be used as the binder of the thermally expansive layer 12. As described later, the thermally expansive layer 12 of the present embodiment is removed by peeling the thermally expansive layer 12 from the base 11 after the base 11 is deformed.

As such, it is preferable that the thermally expansive layer 12 includes a binder that contains a thermoplastic elastomer that makes the thermally expansive layer 12 less likely to break when peeling the thermally expansive layer 12. While not limited hereto, the thermoplastic elastomer is selected from polyvinyl chloride, ethylene propylene rubber (EPR), ethylene-vinyl acetate copolymer (EVA), styrene thermoplastic elastomers, olefin thermoplastic elastomers, urethane thermoplastic elastomers, polyester thermoplastic elastomers, and the like. A styrene thermoplastic elastomer is preferably used as the binder.

The thermally expandable microcapsules contain propane, butane, or a similar low boiling point volatile substance in thermoplastic resin shells.

The shells are formed from a thermoplastic resin such as, for example, polystyrene, polyvinyl chloride, polyvinylidene chloride, polyvinyl acetate, polyacrylic acid ester, polyacrylonitrile, polybutadiene, or copolymers thereof. In one example, the average particle size of the thermally expandable microcapsules is about 5 to 50 μm. When these microcapsules are heated to the thermal expansion start temperature or higher, the shells that are made from the resin soften and the low boiling point volatile substance encapsulated therein vaporizes. The pressure resulting from this vaporization causes the shells to expand in a balloon-like manner. While dependent on the characteristics of the microcapsules to be used, the particle size of the microcapsules expands to about five-times larger than that prior to expansion. Note that there is variance in the particle sizes of the microcapsules and all of the microcapsules do not have the same particle size.

In the present embodiment, particularly, the thermally expansive layer 12 is peeled after the base 11 is deformed. Accordingly, it is desirable that the thermally expansive layer 12 does not break when peeled. Additionally, if the thermally expansive layer 12 peels from the base 11 when causing the thermally expansive layer 12 to distend, the base 11 may not to deform as desired. Therefore, a degree of adhesive strength must be provided between the thermally expansive layer 12 and the base 11 that at least allows the base 11 to conform to the thermally expansive layer 12 and deform. In addition, the breaking strength of the thermally expansive layer 12 is greater than the peeling strength between the thermally expansive layer 12 and the base 11, and it is preferable that breaking strength is at least two-times greater than the peeling strength.

In the present embodiment, the thermally expansive layer 12 is used to deform the base 11 into a desired shape. As such, it is sufficient that the thermally expansive layer 12 has at least a thickness that allows the base 11 to be deformed into the desired shape. Therefore, the thermally expansive layer 12 can be formed with the same or a thinner thickness than the base 11. As a result, the material used to form the thermally expansive layer 12 can be reduced and costs can be reduced. Note that the thickness of the thermally expansive layer 12 may by greater than the thickness of the base 11 in cases in which the thermally expansive layer 12 must be formed thicker such as when, for example, the base 11 is a material that does not easily deform or the shape of the shaped object requires the thermally expansive layer 12 to foam higher.

Production Method for Formable Resin Sheet

The formable resin sheet 10 of the present embodiment is produced as described below.
First, as illustrated in FIG. 2A, a sheet-like material such as, for example, a sheet made from non-oriented PET, is prepared as the base 11. The base 11 may be in a roll shape or may be precut.

Next, the binder including the thermoplastic resin and the like is mixed with the thermally expandable material (the thermally expandable microcapsules) to prepare a coating liquid for forming the thermally expansive layer 12. In the present embodiment, it is preferable that the binder contains a thermoplastic elastomer. While not limited hereto, the thermoplastic elastomer is selected from polyvinyl chloride, ethylene propylene rubber (EPR), ethylene-vinyl acetate copolymer (EVA), styrene thermoplastic elastomers, olefin thermoplastic elastomers, urethane thermoplastic elastomers, polyester thermoplastic elastomers, or the like.

Since the thermally expansive layer 12 is to be peeled after distension, adhesive strength, of at least a degree that at least allows the base 11 to deform by conforming to the thermally expansive layer 12, must be provided between the thermally expansive layer 12 and the base 11. In addition, the breaking strength of the thermally expansive layer 12 is greater than the adhesive strength between the thermally expansive layer 12 and the base 11, and is preferably not less than two-times greater than the adhesive strength. The material of the binder included in the thermally expansive layer 12, the mixing ratio of the binder in the coating liquid, and the like are determined such that these conditions are satisfied. A styrene thermoplastic elastomer is preferably used as the binder.

Then, using a known coating device such as a bar coater, a roll coater, or a spray coater, the coating liquid is applied on the base 11. Next, the coated film is dried, thereby forming the thermally expansive layer 12 as illustrated in FIG. 2B. Note that the application and the drying of the coating liquid may be carried out a plurality of times in order to obtain the target thickness of the thermally expansive layer 12. Additionally, the thermally expansive layer 12 may be formed by using a printing device such as a screen printing device, instead of the coating device. Moreover, in cases in which the base 11 has a roll form, cutting may performed as desired. Thus, the formable resin sheet 10 is obtained.

Shaped Object 20

Next, the drawings are used to describe the shaped object 20. The shaped object 20 is formed as a result of the base 11 deforming due to the thermally expansive layer 12 of the formable resin sheet 10 distending. As described later, with the shaped object 20 of the present embodiment, the thermally expansive layer 12 is peeled and removed after the distension.

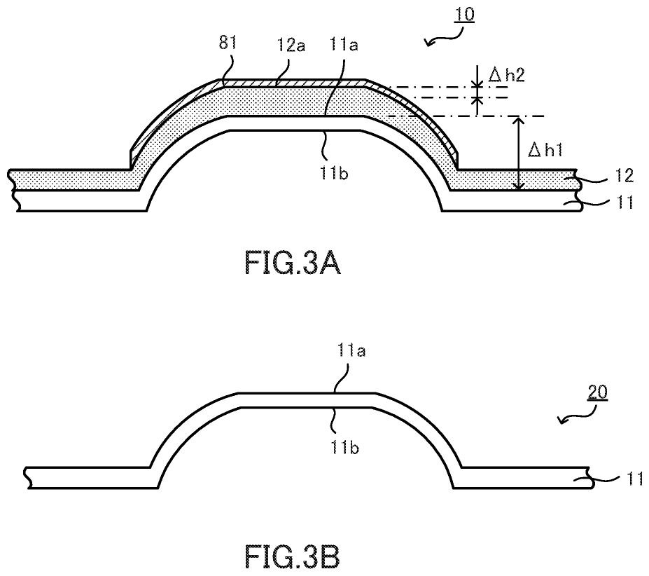

FIG. 3A illustrates the formable resin sheet 10 in a state in which the thermally expansive layer 12 is distended. FIG. 3B illustrates the shaped object 20, with the thermally expansive layer 12 removed. As illustrated in FIG. 3A, after the distension of the thermally expansive layer 12, a protrusion 12a is present on the top surface of the thermally expansive layer 12 of the formable resin sheet 10. Additionally, the base 11 is deformed so as to conform to the distension of the thermally expansive layer 12. As such, a protrusion 11a is present on the top surface of the base 11, and a recess 11b is present in the bottom surface of the base 11. The recess 11b has a shape that corresponds to the protrusion 11a. The protrusion 11a of the base 11 and the protrusion 12a of the thermally expansive layer 12 protrude from the surrounding regions. Additionally, an electromagnetic wave-to-heat conversion layer (hereinafter referred to as “thermal conversion layer”) 81 that converts electromagnetic waves to heat is provided on the protrusion 12a. The thermal conversion layer 81 is used to cause the thermally expansive layer 12 to distend.

While described in detail later, in the present embodiment, the thermal conversion layer 81, which includes an electromagnetic wave-to-heat conversion material that converts electromagnetic waves to heat, is formed on the surface of the front side of the formable resin sheet 10. The thermal conversion layer 81 generates heat as a result of being irradiated with the electromagnetic waves. Examples of the electromagnetic wave-to-heat conversion material include infrared absorbing agents such as cesium tungsten oxide and lanthanum hexaboride, carbon black, and the like. The thermal conversion layer 81 is heated due to being irradiated with electromagnetic waves and, as such, is also called a “heated layer.” The heat generated by the thermal conversion layer 81, which is provided on the surface of the front side of the formable resin sheet 10, is transmitted to the base 11. The heat generated by the thermal conversion layer 81 is also transmitted to the thermally expansive layer 12. As a result, the thermally expandable material in the thermally expansive layer 12 foams and, as a result, the thermally expansive layer 12 distends. The electromagnetic waves are converted to heat more quickly in regions where the thermal conversion layer 81 is provided than in regions where the thermal conversion layer 81 is not provided. As such, the regions near the thermal conversion layer 81 can be exclusively and selectively heated, and specific regions of the thermally expansive layer 12 can be exclusively and selectively caused to distend. Moreover, when the thermally expansive layer 12 foams and distends, the base 11 deforms to a shape that conforms to the distending direction of the thermally expansive layer 12. Furthermore, the base 11 maintains that shape after the deformation.

The protrusion 12a illustrated in FIG. 3A is formed on the thermally expansive layer 12 as a result of the distension of the thermally expansive layer 12. When the protrusion 12a is formed, the distending force of the thermally expansive layer 12 acts in the direction opposite the base 11 (toward the top side illustrated in FIG. 3A). The base 11 deforms as if being pulled in the upward direction illustrated in FIG. 3A by this distending force. Thus, the protrusion 11a is formed in the top surface of the base 11 so as to protrude from the surrounding regions. Additionally, the recess 11b that corresponds to the shape of the protrusion 12a, which is formed on the front side, is formed in the back side of the base 11. The shape of the recess 11b is substantially the same as the shape of the protrusion 11a. That is, the recess 11b has a shape that is smaller than the protrusion 11a the thickness of the base 11. In the present description, the shapes of the protrusion 12a of the thermally expansive layer 12, and the protrusion 11a and the recess 11b of the base 11 are expressed as embossed shapes.

One method of so-called embossing includes forming unevennesses that correspond to top and bottom molds, sandwiching a sheet between the top and bottom molds, and pressing, thereby forming the unevennesses on the front side of the sheet. In contrast, in the present embodiment, the base 11 is deformed by being pulled by the distending force of the thermally expansive layer 12. As such, there is no need for molds. However, the shape after deformation is similar to the shape formed by embossing and, as such, in the present description, the shapes such as the protrusion 12a of the thermally expansive layer 12 and the protrusion 11a and the recess 11b of the base 11 are expressed as embossed shapes.

With the formable resin sheet 10 of the present embodiment, since, in particular, the base 11 is deformed using the thermally expansive layer 12, an amount of deformation Δh1 of the base 11 may be greater than a foaming height Δh2 of the thermally expansive layer 12, as illustrated in FIG. 3A. Note that the amount of deformation Δh1 is the height of the protrusion 11a measured from the surface of a non-deformed region of the base 11. The foaming height (difference) Δh2 of the thermally expansive layer 12 is obtained by subtracting the height of the thermally expansive layer 12 before distension from the height of the thermally expansive layer 12 after distension. The difference Δh2 can also be described as the amount of increase in height of the thermally expansive layer 12, caused by the expansion of the thermally expandable material.

Next, as illustrated in FIG. 3B, the shaped object 20 without the thermally expansive layer 12 is obtained by removing the thermally expansive layer 12 from the formable resin sheet 10 illustrated in FIG. 3A. As illustrated in FIG. 3B, the shaped object 20 includes the protrusion 11a on the top surface, and the recess 11b in the bottom surface. The recess 11b has a shape that corresponds to the protrusion 11a. The protrusion 11a of the shaped object 20 protrudes from the surrounding region. With the shaped object 20, the shapes of the protrusion 11a and the recess 11b are not limited to the shapes illustrated in the drawings, and may be changed as desired.

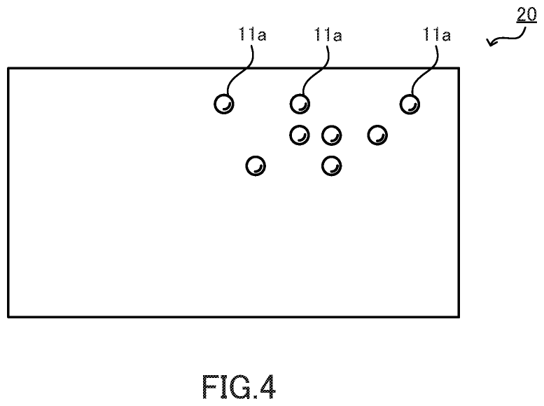

For example, as illustrated in FIG. 4, the shaped object 20 may be Braille dots. In this case, as illustrated in FIG. 4, the shaped object 20 includes a plurality of the protrusions 11a in accordance with the Braille to be expressed. With the shaped object 20 of the present embodiment, the thermally expansive layer 12 is removed. Accordingly, the Braille section can be caused to illuminate by selecting, as the base 11, a sheet that has visible light transmittance and disposing a light source such as a light emitting diode (LED) under the shaped object 20. As a result, the location of the Braille dots can be indicated to a person with impaired vision.

The method of use of the shaped object 20 is not limited to the example illustrated in in FIG. 4, and any method of use is possible. For example, using the shape of the protrusion lla illustrated in FIG. 3B, the shaped object 20 may be used as the dome of a membrane switch. The shaped object 20 may also be used as a key top or a decorative panel of an electronic device. Moreover, the shaped object 20 may be used as a seal or the like. In this case, the shaped object 20 may further include an adhesive layer on the top surface or on the bottom surface. The peeling strength of the adhesive layer may be set as desired. For example, the peeling strength of the adhesive layer may be a strength sufficient to prevent the shaped object 20 from easily peeling from an adherend or may be a strength sufficient to enable the shaped object 20 to be easily peeled after being affixed.

In addition, the shaped object 20 may include a color ink layer (not illustrated in the drawings) on the surface of the front side and/or the surface of the back side of the shaped object 20. The color ink layer is a layer that is formed from an ink that is used in a desired printing device such as an offset printing device, a flexographic printing device, or the like. The color ink layer may be formed from a water-based ink, an oil-based ink, an ultraviolet curable ink, or the like. The color ink layer is a layer that expresses a desired image such as characters, numbers, photographs, patterns, or the like. In particular, when, for example, the color ink layer is formed from a water-based ink, it is preferable that an ink receiving layer (not illustrated in the drawings) that receives the ink is provided and the color ink layer is formed on the back side of the base 11.

Production Method for Shaped Object

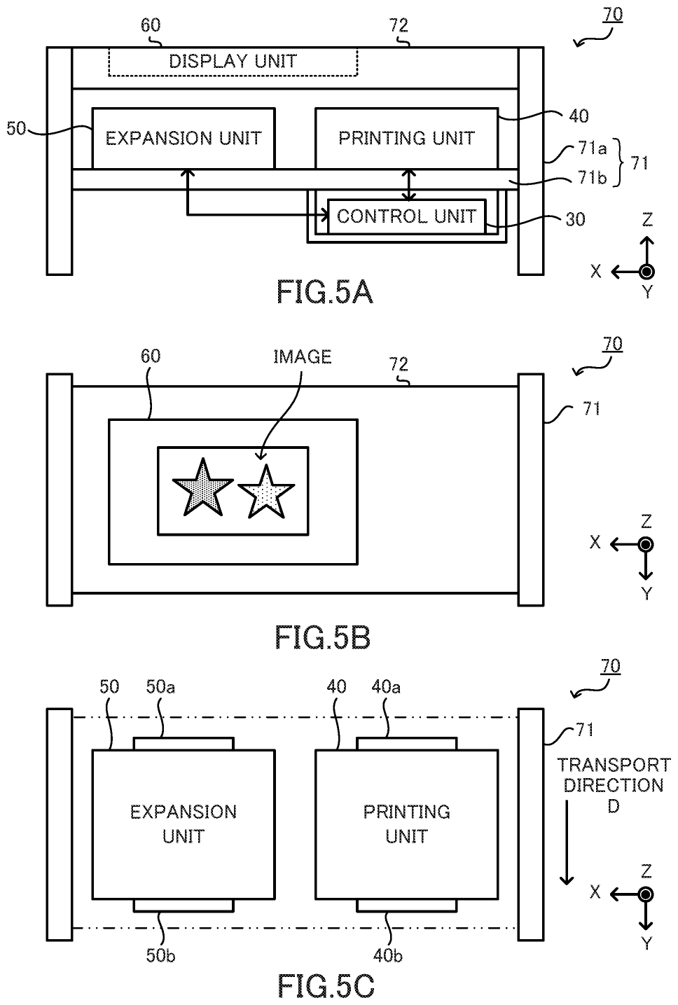

Next, an explanation will be given of the flow of a method in which the formable resin sheet 10 is shaped and the shaped object is produced using a shaping system 70, while referencing FIGS. 5A to 5C, FIG. 6, and FIG. 7. In the production method for the shaped object, an example is given in which individual sheets are used as the formable resin sheet 10, but a configuration is possible in which a formable resin sheet 10 that is wound in a roll-shape is used.

Shaping System

Next, while referencing FIGS. 5A to 5C, a description will be given of a shaping system 70 for shaping the shaped object on the formable resin sheet 10. FIG. 5A is a front view of the shaping system 70. FIG. 5B is a plan view of the shaping system 70 and depicts a state in which a top plate 72 is closed. FIG. 5C is a plan view of the shaping system 70 and depicts a state in which the top plate 72 is open. In FIGS. 5A to 5C, the X-direction corresponds to the direction in which a printing unit 40 and an expansion unit 50 are juxtaposed, the Y-direction corresponds to the transport direction of the formable resin sheet 10 in the printing unit 40 and the expansion unit 50, and the Z-direction corresponds to the vertical direction. The X-direction, the Y-direction, and the Z-direction are orthogonal to each other.

The shaping system 70 includes a control unit 30, a printing unit 40, an expansion unit 50, and a display unit 60.

The control unit 30, the printing unit 40, and the expansion unit 50 are each mounted in a frame 71 as illustrated in FIG. 5A. Specifically, the frame 71 includes a pair of substantially rectangular sideboards 71a and a coupling beam 71b provided between the sideboards 71a. The top plate 72 spans between upper portions of the sideboards 71a. The printing unit 40 and the expansion unit 50 are juxtaposed in the X-direction on the coupling beam 71b that spans between the sideboards 71a, and the control unit 30 is fixed below the coupling beam 71b. The display unit 60 is embedded in the top plate 72 so as to be flush with the top surface of the top plate 72.

Control Unit

The control unit 30 controls the printing unit 40, the expansion unit 50, and the display unit 60. The control unit 30 supplies power to the printing unit 40, the expansion unit 50, and the display unit 60. The control unit 30 includes a controller that includes a central processing unit (CPU) or the like, a storage unit that includes flash memory, a hard disk, or the like, a communicator that is an interface for communicating with external devices, and a non-transitory recording medium driver that reads out programs and data stored on a portable non-transitory recording medium (all not illustrated in the drawings).

Each of these components is connected to a bus for transmitting signals. The non-transitory recording medium driver reads and acquires, from the portable non-transitory recording medium, front side foaming data to be printed by the printing unit 40. The front side foaming data is data that indicates the portion of the front side of the formable resin sheet 10 to be foamed and caused to distend.

Printing Unit

The printing unit 40 acquires image data from the control unit 30 and prints on the front side and/or the back side of the formable resin sheet 10 on the basis of the acquired image data. In the present embodiment, the printing unit 40 is an ink jet printer that prints images via a method in which ink is micronized and directly sprayed on print media. Any desired ink can be used in the printing unit 40. For example, a water-based ink, a solvent-based ink, an ultraviolet-curable ink, or the like can be used in the printing unit 40. Note that the printing unit 40 is not limited to an ink jet printer, and any printing device can be used.

The printing unit 40 includes an ink cartridge that contains ink that contains an electromagnetic wave-to-heat conversion material (thermal conversion material). The electromagnetic wave-to-heat conversion material (thermal conversion material) is a material that is capable of converting electromagnetic waves to heat. While not limited hereto, examples of the thermal conversion material include carbon black (graphite), which is a carbon molecule. As a result of being irradiated with the electromagnetic waves, the graphite absorbs the electromagnetic waves, thermally vibrates, and generates heat. Note that the thermal conversion material is not limited to graphite and, for example, inorganic materials such as cesium tungsten oxide, lanthanum hexaboride, and other infrared absorbing agents can be used.

As illustrated in FIG. 5C, the printing unit 40 includes a loader 40a for loading the formable resin sheet 10, and a discharger 40b for discharging the formable resin sheet 10. The printing unit 40 prints a designated image on the front side and/or the back side of the formable resin sheet 10 loaded through the loader 40a, and discharges the formable resin sheet 10 on which the image is printed through the discharger 40b.

Expansion Unit

The expansion unit 50 irradiates the front side and/or the back side of the formable resin sheet 10 with electromagnetic waves, thereby causing at least a portion of the thermally expansive layer to distend. The expansion unit 50 includes a lamp heater, a reflection plate that reflects the electromagnetic waves emitted from the lamp heater toward the formable resin sheet 10, a temperature sensor that measures the temperature of the reflection plate, a cooler that cools the interior of the expansion unit 50, a pair of transport rollers that sandwiches and transports the formable resin sheet 10 along a transport guide, and a transport motor for rotating the pair of transport rollers (all not illustrated in the drawings).

In one example, the lamp heater includes a halogen lamp. The lamp heater emits, at the formable resin sheet 10, electromagnetic waves (light) in the near-infrared region (750 to 1400 nm wavelength range), the visible light spectrum (380 to 750 nm wavelength range), or the intermediate infrared region (1400 to 4000 nm wavelength range). When the formable resin sheet 10, on which the thermal conversion layer formed from the heat converting ink (heat generating ink) that contains the thermal conversion material is printed, is irradiated with electromagnetic waves, the portions where the thermal conversion layer is printed convert the electromagnetic waves to heat more efficiently than the portions where the thermal conversion layer is not printed. As such, the portions of the formable resin sheet 10 where the thermal conversion layer is printed are mainly heated and, when the temperature at which expansion begins is reached, the thermally expandable material expands. Note that the irradiator is not limited to a halogen lamp and other configurations may be used provided that it is possible to emit electromagnetic waves. Moreover, the wavelengths of the electromagnetic waves are not limited to the ranges described above.

The expansion unit 50 irradiates the front side and/or the back side of the formable resin sheet 10 with electromagnetic waves, thereby causing at least a portion of the thermally expansive layer to distend. As illustrated in FIG. 5C, the expansion unit 50 includes a loader 50a for loading the formable resin sheet 10, and a discharger 50b for discharging the formable resin sheet 10. The expansion unit 50 irradiates the front side and/or the back side of the formable resin sheet 10 loaded through the loader 50a with electromagnetic waves, thereby causing at least a portion of the thermally expansive layer to distend, and discharges the formable resin sheet 10 that includes the distended thermally expansive layer through the discharger 50b.

In the expansion unit 50, the formable resin sheet 10 is transported through the loader 50a into the unit and is subjected to the electromagnetic waves emitted by the irradiator while being transported by the pair of transport rollers. As a result, the portions of the formable resin sheet 10 where the thermal conversion layer 81 is printed are heated. This heat is transmitted to the thermally expansive layer 13 and at least a portion of the thermally expansive layer 13 distends. The formable resin sheet 10 that is heated and caused to distend in this manner is discharged through the discharger 50b.

Display Unit

The display unit 60 includes a display device such as a liquid crystal display or an organic electro luminescence (EL) display, and a display driving circuit that causes images to be displayed on the display device. In the example illustrated in FIG. 5B, the display unit 60 displays an image (for example, the stars illustrated in FIG. 5B) to be printed on the formable resin sheet 10 by the printing unit 40. Additionally, as desired, the display unit 60 may display information indicating the current state of the printing unit 40 and/or the current state of the expansion unit 50.

While not illustrated in the drawings, the shaping system 70 may include an operation unit that is operated by a user. The operation unit includes buttons, switches, dials, and the like and receives operations for the printing unit 40 or the expansion unit 50. Alternatively, the display unit 60 may include a touch panel or a touch screen in which the display device and the operation device are stacked.

According to the shaping system 70 of the present embodiment, by controlling the densities of the thermal conversion layers (the front side foaming data and the back side foaming data), controlling the electromagnetic waves, and the like, the amount of expansion of the thermally expandable material can be controlled, the height to which the thermally expansive layer 13 rises can be controlled, and the desired protrusions or uneven shapes can be formed on the front side of the formable resin sheet 10.

Here, the phrase “controlling the electromagnetic waves” refers to controlling, in order to cause the formable resin sheet 10 to rise to a desired height, the amount of energy that the formable resin sheet 10 receives per unit area when causing the formable resin sheet 10 to distend in the shaping system 70 by irradiating the formable resin sheet 10 with the electromagnetic waves. Specifically, the amount of energy that the formable resin sheet 10 receives per unit area changes depending on parameters such as the irradiation intensity, the movement speed, the irradiation time, and the irradiation distance of the irradiator, temperature, humidity, and cooling. The controlling of the electromagnetic waves is performed by controlling one or more of these parameters.

Production Method for Shaped Object

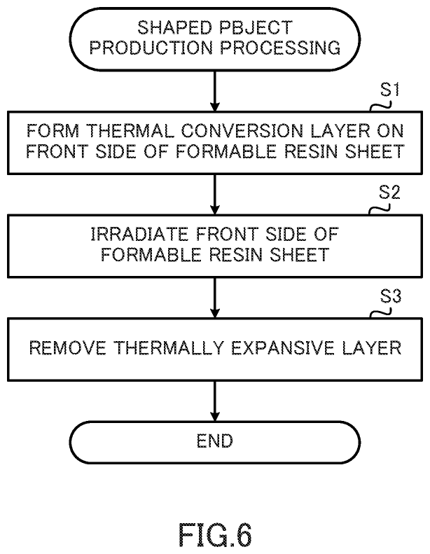

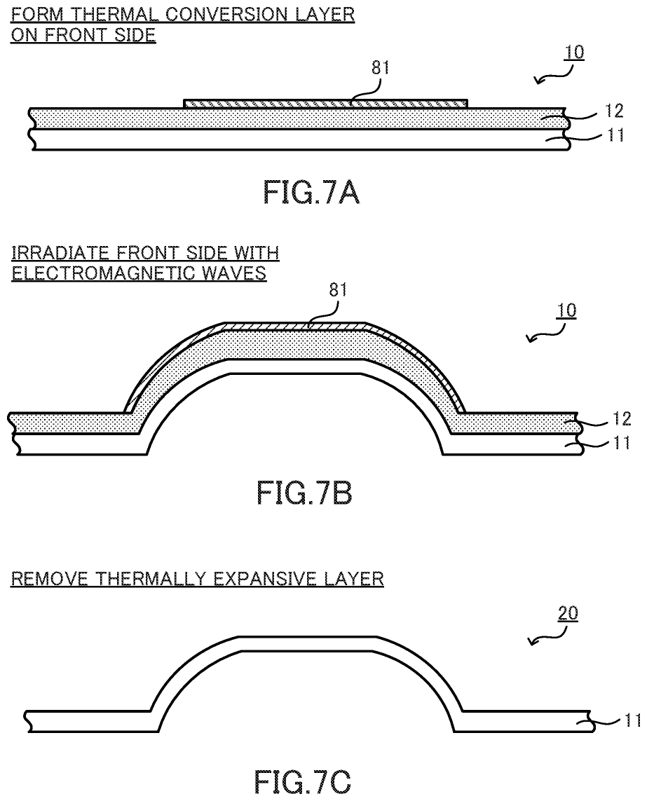

Next, an explanation will be given of the flow of processing whereby the formable resin sheet 10 is formed and the shaped object 20 is obtained, while referencing the flowchart illustrated in FIG. 6, and the cross-sectional views of the formable resin sheet 10 illustrated in FIGS. 7A to 7C.

First, the formable resin sheet 10 is prepared. Foaming data (data for forming the thermal conversion layer 81) is determined in advance. The foaming data indicates the portion of the front side of the formable resin sheet 10 to be foamed and caused to distend. The formable resin sheet 10 is transported to the printing unit 40 with the front side of the formable resin sheet 10 facing upward. The thermal conversion layer 81 is printed on the front side of the formable resin sheet 10 (step S1). The thermal conversion layer 81 is formed from an ink that contains the electromagnetic wave-to-heat conversion material. For example, the thermal conversion layer 81 is formed from carbon black-containing foamable ink. The printing unit 40 discharges the thermal conversion material-containing foamable ink onto the front side of the formable resin sheet 10 in accordance with the designated foaming data. As a result, the thermal conversion layer 81 is formed on the front side of the formable resin sheet 10, as illustrated in FIG. 7A. Note that, when the thermal conversion layer 81 is printed with greater density, the amount of generated heat increases and, as a result, the thermally expansive layer 12 rises higher. Accordingly, a large amount of deformation of the base 11 can be obtained. Thus, the deformation height of can be controlled by controlling the density of the thermal conversion layer 81.

Second, the formable resin sheet 10 onto which the thermal conversion layer 81 is printed is transported to the expansion device 50 such that the front side of the formable resin sheet 10 faces upward. In the expansion device 50, the transported formable resin sheet 10 is irradiated with electromagnetic waves by the irradiator 51 (step S2). Specifically, in the expansion device 50, the irradiator 51 irradiates the front side of the formable resin sheet 10 with electromagnetic waves. The thermal conversion material, included in the thermal conversion layer 81 printed on the front side of the formable resin sheet 10, absorbs the irradiated electromagnetic waves, thereby generating heat. As a result, the thermal conversion layer 81 generates heat and this heat is transmitted to the base 11. Furthermore, the heat generated by the thermal conversion layer 81 is transmitted to the thermally expansive layer 12, and the thermally expansive material foams and distends. As a result, as illustrated in FIG. 7B, the region of the thermally expansive layer 12 of the formable resin sheet 10 where the thermal conversion layer 81 is printed distends and rises. Additionally, the base 11 is deformed by being pulled by the distending force of the thermally expansive layer 12.

Third, the thermally expansive layer 12 is peeled and removed from the base 11 (step S3). Specifically, a portion of the thermally expansive layer 12 at an end of the formable resin sheet 10 is peeled from the base 11. Then, the thermally expansive layer 12 is pulled and peeled from the base 11. The peeling may be performed manually, or may be performed using a tool, a machine, or the like. As a result, as illustrated in FIG. 7C, the shaped object 20, from which the thermally expansive layer 12 has been peeled, is obtained.

The base 11 of the formable resin sheet 10 deforms and the shaped object 20 is produced as a result of carrying out the procedures described above.

In the foregoing, a configuration example is described in which the thermal conversion layer 81 is provided on the thermally expansive layer 12. Forming the thermal conversion layer 81 on the thermally expansive layer 12 is preferable because the thermal conversion layer 81 is also removed when peeling and removing the thermally expansive layer 12, and the thermal conversion layer 81 does not remain on the shaped object 20. However, depending on the application of the formable resin sheet 10, it is also possible to provide the thermal conversion layer 81 on the back side of the base 11. Moreover, it is possible to provide the thermal conversion layer 81 on both the thermally expansive layer 12 and the back side of the base 11.

In an embodiment such as that described above, the formable resin sheet 10 can easily be deformed to a desired shape by forming the thermal conversion layer 81 by printing the thermal conversion layer 81 and irradiating the thermal conversion layer 81 with the electromagnetic waves. In particular, since the base 11 can be deformed by causing the thermally expansive layer 12 to distend, the need for molds or the like for the shaping is eliminated, and the time and cost required for shaping the formable resin sheet 10 can be reduced.

In the present embodiment, controlling the densities of the thermal conversion layers (the foaming data) 81, controlling the electromagnetic waves, and the like, the position of and the height to which the thermally expansive layer 12 rises can be controlled as desired, the formable resin sheet 10 can easily be shaped, and the shaped object can easily be formed. In addition, the present embodiment, since molds are not needed, a particularly excellent benefit is demonstrated in prototype fabrication at the product development stage.

### Embodiment 2

Next, the drawings are used to describe a formable resin sheet 15 according to Embodiment 2. The formable resin sheet 15 according to the present embodiment differs from the formable resin sheet 10 according to Embodiment 1 in that the formable resin sheet 15 includes an intermediate layer 16 between the base 11 and the thermally expansive layer 12. Features that are the same as those described in Embodiment 1 are marked with the same reference numerals and detailed descriptions thereof are forgone.

Formable Resin Sheet 15

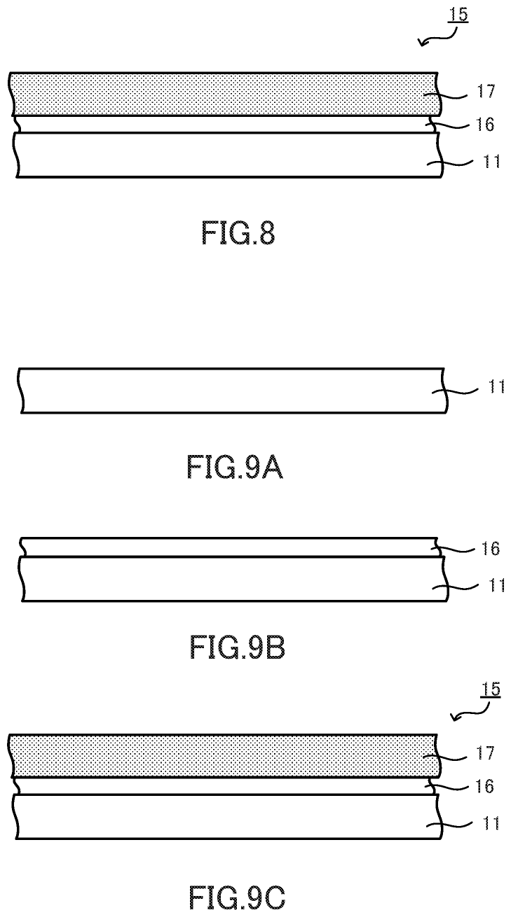

As illustrated in FIG. 8, the formable resin sheet 15 includes a base 11, an intermediate layer 16, and a thermally expansive layer 17. The base 11 is the same as the base 11 of the formable resin sheet 10 of Embodiment 1.

The intermediate layer 16 is provided on a first side (the top surface illustrated in FIG. 8) of the base 11. The intermediate layer 16 is peelably adhered to the base 11. The thermally expansive layer 17 is provided on the intermediate layer 16. In the present embodiment, the intermediate layer 16 is provided between the base 11 and the thermally expansive layer 17. Furthermore, the peeling strength between the intermediate layer 16 and the base 11 is weaker than the peeling strength between the intermediate layer 16 and the thermally expansive layer 17. As such, the thermally expansive layer 17 can be peeled and removed from the base 11. To prevent the thermally expansive layer 17 from peeling before being caused to distend, the intermediate layer 16 must not peel from the base 11 by typical actions of a user (such as a user carrying the formable resin sheet 15). Furthermore, it is preferable that the intermediate layer 16 have elasticity to conform to the deformation of the base 11. In addition, it is preferable that the intermediate layer 16 have breaking strength sufficient to prevent internal breakage of the intermediate layer 16 when peeling the thermally expansive layer 17. A slightly adhesive film obtained by providing an adhesive with slight adhesion, such as an acrylic adhesive or a silicone adhesive, on a first side of a resin film can be used as this intermediate layer 16. The resin film is formed from a resin selected from, for example, polyester, polyethylene, polyvinyl alcohol, and polyethylene terephthalate, or a copolymer thereof. A film formed from ethylene-vinyl alcohol copolymer can be used as the film of the intermediate layer 16. Provided that the adhesive strength of the adhesive is 0.06 N/20 mm or greater when measured by a 180° peeling strength test, peeling of the intermediate layer 16 from the base 11 due to typically actions of a user can be substantially prevented

The thermally expansive layer 17 is provided on the intermediate layer 16. Like the thermally expansive layer 12 described in Embodiment 1, the thermally expansive layer 17 is a layer that distends to a size that corresponds to the heating process (for example, the heating temperature and the heating time), and includes a thermally expandable material (thermally expandable microcapsules, micropowder) dispersed/disposed in a binder. The materials of the binder and the thermally expandable material are the same as in Embodiment 1. Note that, in the present embodiment, the thermally expansive layer 17 is peeled from the base 11 using the intermediate layer 16 and, as such, the breaking strength of the thermally expansive layer 17 in the present embodiment may be lower than the thermally expansive layer 17 of Embodiment 1. The thermally expansive layer 17 is not limited to including one layer and may include a plurality of layers.

Production Method for Formable Resin Sheet

The formable resin sheet 15 of the present embodiment is produced as described below.

First, as illustrated in FIG. 9A, a sheet-like material such as, for example, a sheet made from non-oriented PET is prepared as the base 11. The base 11 may be in a roll shape or may be precut.

Next, the intermediate layer 16 is affixed to the base 11 by a laminating apparatus that includes an input roller, a heater roller, a roller, and an output roller. A resin film on which an adhesive is provided on the side facing the base 11 is used as the intermediate layer 16. In one example, while in a wound state, the base 11 is placed at an unwinding position of the laminating apparatus. Then, the base 11 passes between the pair of input rollers and is transported toward the heater roller and the roller. The film used as the intermediate layer 16 is fed to the heater roller. When the film is heated by the heater roller and passes between the heater roller and the roller, pressure is applied and the film is peelably adhered to the base 11. After the film has been adhered, the base 11 passes between the pair of output rollers, is transported, and wound up.

Thus, the intermediate layer 16 is affixed to the base 11, as illustrated in FIG. 9B.

Next, as in Embodiment 1, the binder made from the thermoplastic resin and the like is mixed with the thermally expandable material (the thermally expandable microcapsules) to prepare a coating liquid for forming the thermally expansive layer 17. Note that the application and the drying of the coating liquid may be carried out a plurality of times in order to obtain the target thickness of the thermally expansive layer 17. In the present embodiment, since the thermally expansive layer 17 is peeled by the intermediate layer 16, the thermally expansive layer 17 need not have the breaking strength described in Embodiment 1.

Next, the coating liquid is applied on the base 11 using a known coating device such as a bar coater, a roll coater, or a spray coater, or a printing device such as a screen printing device. Then, the coated film is dried. Thus, the thermally expansive layer 17 is formed as illustrated in FIG. 9C. Moreover, in cases in which the base 11 is provided in a roll form, cutting may performed as desired. Thus, the formable resin sheet 15 is obtained.

Shaped Object 21

Next, the drawings are used to describe a shaped object 21. The shaped object 21 is formed by the base 11 deforming due to the distending of the thermally expansive layer 17 of the formable resin sheet 15. As described later, with the shaped object 21 of the present embodiment, the thermally expansive layer 17 is peeled and removed after the distending.

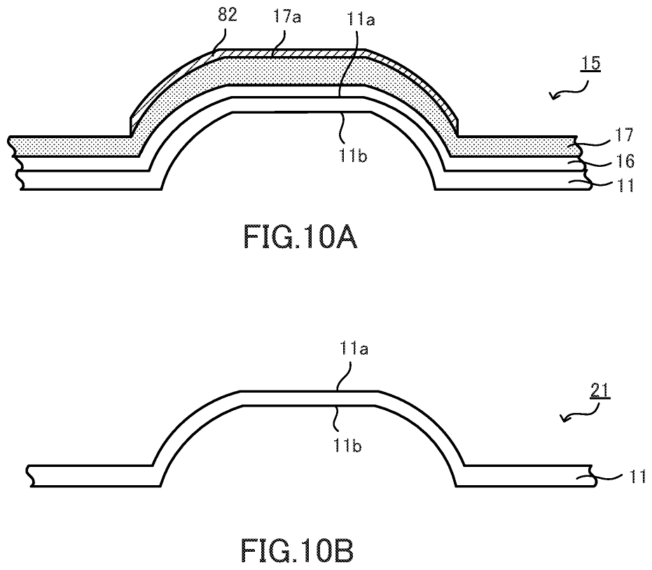

FIG. 10A illustrates the formable resin sheet 15 in a state in which the thermally expansive layer 17 is distended, and FIG. 10B illustrates the shaped object 21, with the thermally expansive layer 17 removed. As illustrated in FIG. 10A, in the formable resin sheet 15 after the distending of the thermally expansive layer 17, the thermally expansive layer 17 includes a protrusion 17a on the top surface, the same as in Embodiment 1. Additionally, the base 11 is deformed so as to conform to the distending of the thermally expansive layer 17. A thermal conversion layer 82 for causing the thermally expansive layer 17 to distend is provided on the protrusion 17a.

As illustrated in FIG. 10B, the shaped object 21 from which the thermally expansive layer 17 is removed includes a protrusion Ila on the top surface, and a recess 11b in the bottom surface. The recess 11b has a shape that corresponds to the protrusion 11a. As in Embodiment 1, in the shaped object 21, the shapes of the protrusion 11a and the recess 11b can be changed as desired, and any method of use thereof is possible. Additionally, the shaped object 21 may include a color ink layer (not illustrated in the drawings) on the surface of the front side and/or the surface of the back side of the shaped object 21.

Production Method for Shaped Object

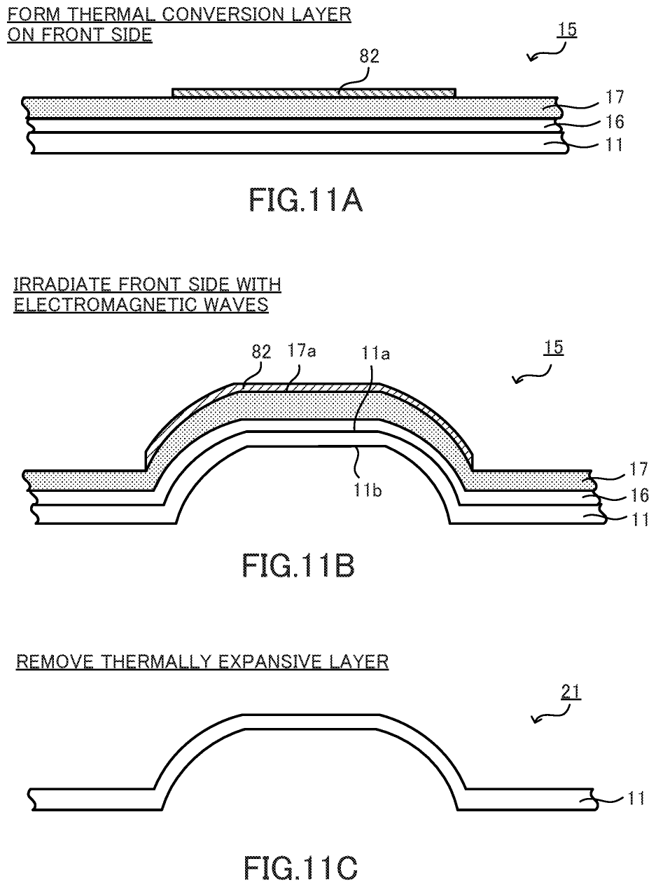

Next, an explanation will be given of the flow of processing whereby the formable resin sheet 15 is formed and the shaped object 21 is obtained, while referencing the flowchart illustrated in FIG. 6, and the cross-sectional views of the formable resin sheet 15 illustrated in FIGS. 11A to 11C. Since the flow of processing is the same as in Embodiment 1, the flowchart described in Embodiment 1 is used.

First, as in Embodiment 1, the thermal conversion layer 82 is printed on the front side of the formable resin sheet 15, as illustrated in FIG. 11A (step S1). Next, the formable resin sheet 15 onto which the thermal conversion layer 82 is printed is transported to the expansion device 50 such that the front side of the formable resin sheet 15 faces upward, and the formable resin sheet 15 is irradiated with electromagnetic waves by the irradiator 51 (step S2). As a result, the thermal conversion layer 82 generates heat and this heat is transmitted to the base 11. Furthermore, the heat generated by the thermal conversion layer 82 is transmitted to the thermally expansive layer 17, and the thermally expansive material foams and distends. As illustrated in FIG. 11B, the base 11 is deformed by being pulled by the distending force of the thermally expansive layer 17.

Third, the thermally expansive layer 17 is peeled and removed from the base 11 (step S3). Specifically, in the present embodiment, a portion of the intermediate layer 16 at an end of the formable resin sheet 15 is peeled from the base 11. Then, the intermediate layer 16 and the thermally expansive layer 17 provided thereon are pulled and peeled from the base 11. The peeling may be performed manually, or may be performed using a tool, machine, or the like. As a result, as illustrated in FIG. 11C, the shaped object 21, from which the thermally expansive layer 17 has been peeled, is obtained.

The base 11 of the formable resin sheet 15 is deformed and the shaped object 21 is produced as a result of carrying out the procedures described above.

In the present embodiment as well, forming the thermal conversion layer 82 on the thermally expansive layer 17 is preferable because the thermal conversion layer 82 does not remain on the shaped object 21. However, as in Embodiment 1, depending on the application of the formable resin sheet 15, it is also possible to provide the thermal conversion layer 82 on the back side of the base 11. Moreover, it is possible to provide the thermal conversion layer 82 on both the thermally expansive layer 12 and the back side of the base 11.

As with Embodiment 1, with the formable resin sheet and the production method for a shaped object of the present embodiment, the formable resin sheet 15 can easily be deformed to a desired shape by forming the thermal conversion layer 82 by printing and irradiating the thermal conversion layer 82 with the electromagnetic waves.

### Embodiment 3

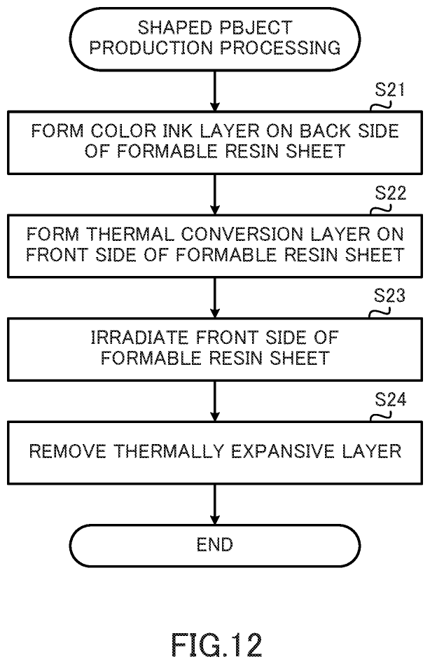

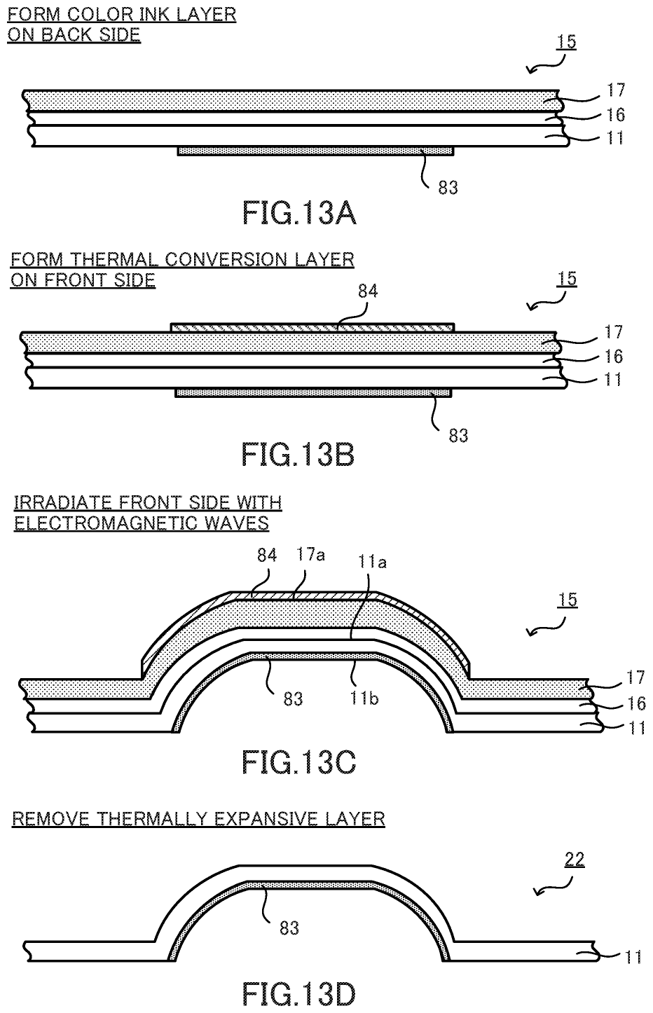

Next, FIG. 12 and FIGS. 13A to 13D are used to describe a production method for a shaped object according to Embodiment 3. The present embodiment is characterized by using the formable resin sheet 15 described in Embodiment 2 and including a color ink layer 83 on the back side of the base 11. Detailed descriptions of constituents that are the same as those described in the preceding embodiments are forgone.

First, the formable resin sheet 15 described in Embodiment 2 is prepared. Color image data for forming the color ink layer 83 on the back side of the formable resin sheet 15 is determined in advance. The formable resin sheet 15 is transported to the printing unit 40 with the back side of the formable resin sheet 15 facing upward. The color ink layer 83 is printed on the back side of the formable resin sheet 15 as illustrated in FIG. 13A (step S21). The printing unit 40 includes ink cartridges of cyan, magenta, and yellow color inks and uses these inks to express the color image. A water-based ink, an oil-based ink, an ultraviolet curable ink, or the like can be used to form the color ink layer 83. Note that, when a water-based ink is used, it is preferable that an ink receiving layer (not illustrated in the drawings) for receiving the ink is provided on the back side of the base 11. When the base 11 is transparent, the color ink layer 83 may be formed using translucent ink. The color ink layer 83 may be formed at any location. For example, the color ink layer 83 may be formed in the region where the recess is to be formed and also in regions other than where the recess is to be provided.

Second, a thermal conversion layer 84 is formed on the front side of the formable resin sheet 15. The foaming data (data for forming the thermal conversion layer 84) that indicates the portion of the formable resin sheet 15 to be foamed and caused to distend is determined in advance. The formable resin sheet 15 is transported to the printing unit 40 with the front side of the formable resin sheet 15 facing upward. The thermal conversion layer 84 is printed on the front side of the formable resin sheet 15 (step S22). As a result, the thermal conversion layer 84 is formed on the front side of the formable resin sheet 15, as illustrated in FIG. 13B. Note that it is possible to reverse the order in which steps S21 and S22 are performed.

Third, the formable resin sheet 15 onto which the thermal conversion layer 84 is printed is transported to the expansion device 50 such that the front side of the formable resin sheet 15 faces upward. In the expansion device 50, the transported formable resin sheet 15 is irradiated with electromagnetic waves by the irradiator (step S23). As a result, the thermal conversion layer 84 generates heat and this heat is transmitted to the base 11. Furthermore, the heat generated by the thermal conversion layer 84 is transmitted to the thermally expansive layer 17, and the thermally expansive material foams and distends. As a result, the region of the thermally expansive layer 17 of the formable resin sheet 15 where the thermal conversion layer 84 is printed distends and rises. As illustrated in FIG. 13C, the base 11 is deformed by being pulled by the distending force of the thermally expansive layer 17.

Fourth, the thermally expansive layer 17 is peeled and removed from the base 11 (step S24). A portion of the intermediate layer 16 at an end of the formable resin sheet 15 is peeled from the base 11. Then, the intermediate layer 16 and the thermally expansive layer 17 provided thereon are pulled and peeled from the base 11. As a result, a shaped object 22 that includes the color ink layer 83 is obtained.

In an embodiment such as that described above, as in Embodiment 1, the formable resin sheet 15 can easily be deformed to a desired shape. In addition, in the present embodiment, due to the color ink layer 83 being formed on the back side of the formable resin sheet 15 prior to the deformation of the base 11, the color ink layer 83 remains even after the thermally expansive layer 17 is peeled. Typically, it is difficult to form a color ink layer 83 on the back side of the base 11, especially in the recess 11b after the deformation of the base 11. However, in the present embodiment, the color ink layer 83 is formed prior to the deformation of the base 11, and this makes it possible to provide an excellent color ink layer 83, particularly in the recess 11b of the base 11.

The present disclosure is not limited to the embodiments described above and various modifications and uses are possible.

For example, in Embodiment 3, an example is described in which the formable resin sheet 15 of Embodiment 2 is used, but a configuration is possible in which the formable resin sheet 10 of Embodiment 1 is used to form the shaped object.

In the embodiments described above, an example is given of a configuration in which, when forming the thermal conversion layer on the front side of the formable resin sheet, the front side of the thermal conversion layer is irradiated with the electromagnetic waves. However, the present application is not limited thereto. For example, a configuration is possible in which the thermal conversion layer is formed on the front side of the formable resin sheet and the back side of the formable resin sheet is irradiated with the electromagnetic waves.

In the embodiment described above, an example is given of a configuration in which the shaping system 70 that includes the printing unit 40 and the expansion unit 50 in a frame is used. However, the present application is not limited thereto and a configuration is possible in which the printing unit 40 and the expansion unit 50 are provided separately. Additionally, the printing unit 40 is not limited to an ink jet printer, and any printing device, such as an offset printing device, a flexographic printing device, or the like can be used.

The drawings used in the various embodiments are provided for the purpose of explaining the various embodiments. Accordingly, the thicknesses of the various layers of the formable resin sheet should not be construed as being limited to the ratios illustrated in the drawings. In the drawings used in the various embodiments, the thermal conversion layer and the like that are provided on the front side and/or the back side of the formable resin sheet are highlighted for the sake of description. Accordingly, the thicknesses of the thermal conversion layer and the like should not be construed as being limited to the ratios illustrated in the drawings.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A formable resin sheet, comprising:
a base made from a resin; and
a thermally expansive layer provided on a first side of the base and including a thermally expandable material, wherein
a breaking strength of the thermally expansive layer is greater than a peeling strength of the thermally expansive layer from the base, and the thermally expansive layer is peelable from the base.

2. The formable resin sheet according to claim 1, wherein the breaking strength of the thermally expansive layer is at least two-times the peeling strength of the thermally expansive layer from the base.

3. The formable resin sheet according to claim 1, wherein the base comprises a thermoplastic resin, and a binder included in the thermally expansive layer is a thermoplastic elastomer.

4. The formable resin sheet according to claim 1, wherein:
the base is deformable in accordance with distension of the thermally expansive layer, and
an amount of deformation in a height of the base when the base deforms is greater than a distension height of the thermally expansive layer when the thermally expansive layer is distended.

5. The formable resin sheet according to claim 3, wherein:
the amount of deformation is a difference in height between a front side of a non-deformation region of the base and a front side of a region where the base is deformed, and
a distension height of the thermally expansive layer is a height obtained by subtracting a height of the thermally expansive layer before distension from the height of the thermally expansive layer after distension.

6. A formable resin sheet, comprising:
a base made from a resin;
a thermally expansive layer provided on a first side of the base and including a thermally expandable material; and
an intermediate layer provided between the base and the thermally expansive layer, wherein
a peeling strength between the intermediate layer and the base is less than a peeling strength between the thermally expansive layer and the intermediate layer, and the intermediate layer is peelable from the base together with the thermally expansive layer.

7. The formable resin sheet according to claim 6, wherein the intermediate layer is an adhesive film that is a resin film with an adhesive applied to one side of the resin film.

8. The formable resin sheet according to claim 7, wherein an adhesive strength of the adhesive is 0.06 N/20 mm or greater.

9. The formable resin sheet according to claim 6, wherein a color ink layer is provided on a second side of the base.

10. A method for producing a formable resin sheet, the method comprising:
forming a thermally expansive layer on a first side of a base that is made from a resin, the thermally expansive layer including a thermally expandable material, wherein
a breaking strength of the thermally expansive layer is greater than a peeling strength of the thermally expansive layer from the base, thereby making the thermally expansive layer peelable from the base.

11. A method for producing a formable resin sheet, the method comprising:
forming an intermediate layer on a first side of a base that is made from a resin; and
forming a thermally expansive layer on the intermediate layer, the thermally expansive layer inscluding a thermally expandable material, wherein
a peeling strength between the intermediate layer and the base is less than a peeling strength between the thermally expansive layer and the intermediate layer, thereby making the intermediate layer peelable from the base together with the thermally expansive layer.

12. A method for producing a shaped object using a formable resin sheet that includes a base and a thermally expansive layer formed on a first side of the base and including a thermally expandable material, wherein a breaking strength of the thermally expansive layer is greater than a peeling strength of the thermally expansive layer from the base, and the thermally expansive layer is peelable from the base, the method comprising:
forming, on at least one of the thermally expansive layer or the base, a thermal conversion layer that converts electromagnetic waves to heat;
irradiating the thermal conversion layer with the electromagnetic waves to cause the thermally expansive layer to distend and cause the base to deform as the thermally expansive layer distends; and
peeling the thermally expansive layer from the base.

13. The method according to claim 12, wherein the base is a thermoplastic resin, and a binder included in the thermal conversion layer is a styrene elastomer.

14. A method for producing a shaped object using a formable resin sheet that includes a base and a thermally expansive layer formed on a first side of the base and including a thermally expandable material, wherein an intermediate layer is provided between the thermally expansive layer and the base, and a peeling strength between the intermediate layer and the base is less than a peeling strength between the thermally expansive layer and the intermediate layer, thereby making the intermediate layer peelable from the base together with the thermally expansive layer, the method comprising:
forming, on at least one of the thermally expansive layer or the base, a thermal conversion layer that converts electromagnetic waves to heat;
irradiating the thermal conversion layer with the electromagnetic waves to cause the thermally expansive layer to distend and cause the base to deform as the thermally expansive layer distends; and
peeling the thermally expansive layer from the base.

15. The production method according to claim 14, wherein the intermediate layer is an adhesive film that is a resin film with an adhesive applied to one side of the resin film.

16. The production method according to claim 15, wherein an adhesive strength of the adhesive is 0.06 N/20 mm or greater.

17. The production method according to claim 14, further comprising:
forming a color ink layer on a second side of the base, wherein
the forming of the color ink layer is performed before the irradiating of the thermal conversion layer with the electromagnetic waves.
